(19) United States
(12) Patent Application Publication
(10) Pub. No.: US 2022/0382037 A1
(43) Pub. Date: Dec. 1, 2022

(54) OBSERVATION DEVICE

(71) Applicant: Evident Corporation, Kamiina-gun (JP)

(72) Inventor: Yoshihiro KAZAMA, Tokyo (JP)

(73) Assignee: Evident Corporation, Kamiina-gun (JP)

(21) Appl. No.: 17/748,637

(22) Filed: May 19, 2022

(30) Foreign Application Priority Data
May 25, 2021 (JP) 2021-087638

(51) Int. Cl. G02B 21/36; G02B 21/02; G02B 21/26; G02B 21/08

(52) U.S. Cl. CPC G02B 21/36; G02B 21/02; G02B 21/26; G02B 21/082

(57) ABSTRACT

An observation device includes: a macro observation system; and a micro observation system. The macro observation system and the micro observation system are arranged so as to satisfy a first condition. The first condition is that a distance from a macro optical axis to a micro optical axis is equal to or less than a square root of a sum of squares of a first distance and a second distance. The first distance is a distance between the macro optical axis and a central axis of an outer diameter of the nosepiece. The second distance is a distance in a first direction between the central axis of the outer diameter and a side surface of the nosepiece. The first direction is a direction orthogonal to the macro optical axis and orthogonal to a line segment connecting the macro optical axis and the central axis of the outer diameter.

### CROSS REFERENCE TO RELATED APPLICATIONS

This application is based upon and claims the benefit of priority from prior Japanese Patent Application No. 2021-087638, filed May 25, 2021, the entire contents of which are incorporated herein by this reference.

### TECHNICAL FIELD

The disclosure herein relates to an observation device.

### BACKGROUND

In a general observation device, it takes much time to observe an entire container such as a well plate. This is because the field of view is too narrow with respect to the entire container. In order to quickly observe the entire container, a macro observation system that has a large-diameter lens and has both a wide field of view and high telecentricity is effective. Such a technique is described in, for example, JP 2011-170074 A. The efficiency of the observation work can be improved by using the macro observation system.

In addition, JP 2007-006852 A describes a microscope in which a macro observation system and a micro observation system are provided together. The efficiency of the observation work can be further improved by using the device including the macro observation system and the micro observation system.

### SUMMARY

An observation device according to an aspect of the present invention includes: a macro observation system that captures an image of a sample at a reduced magnification; and a micro observation system that includes a nosepiece to which a plurality of objective lenses is mountable, and captures an image of the sample at an equal magnification or an increased magnification. The macro observation system and the micro observation system are arranged so as to satisfy a first condition. The first condition is that a distance from a macro optical axis which is an optical axis of the macro observation system to a micro optical axis which is an optical axis of the micro observation system is equal to or less than a square root of a sum of squares of a first distance and a second distance. The first distance is a distance between the macro optical axis and a central axis of an outer diameter of the nosepiece. The second distance is a distance in a first direction between the central axis of the outer diameter and a side surface of the nosepiece. The first direction is a direction orthogonal to the macro optical axis and orthogonal to a line segment connecting the macro optical axis and the central axis of the outer diameter.

### BRIEF DESCRIPTION OF DRAWINGS

The present invention will be more apparent from the following detailed description when the accompanying drawings are referenced.

FIG. 1 is a perspective view of an observation device according to a first embodiment;

FIG. 2 is a top view of the observation device according to the first embodiment;

FIG. 3 is a diagram for explaining an example of a desirable arrangement relationship between a macro observation system and a micro observation system according to the first embodiment;

FIG. 4 is a diagram for explaining an example of an undesirable arrangement relationship between the macro observation system and the micro observation system;

FIG. 5 is a diagram illustrating a movable range of an electric stage in the arrangement relationship illustrated in FIG. 3;

FIG. 6 is a diagram illustrating a movable range of the electric stage in the arrangement relationship illustrated in FIG. 4;

FIG. 7 is a diagram for explaining another example of a desirable arrangement relationship between the macro observation system and the micro observation system according to the first embodiment;

FIG. 8 is a top view of the observation device with the arrangement relationship illustrated in FIG. 7;

FIG. 9 is a diagram for explaining still another example of a desirable arrangement relationship between the macro observation system and the micro observation system according to the first embodiment;

FIG. 10 is a top view of the observation device with the arrangement relationship illustrated in FIG. 9;

FIG. 11 is a diagram for explaining an example of a desirable arrangement of an epi-illumination system according to the first embodiment;

FIG. 12 is a top view of the observation device with the arrangement illustrated in FIG. 11;

FIG. 13 is a diagram for explaining another example of a desirable arrangement of the epi-illumination system according to the first embodiment;

FIG. 14 is a diagram for explaining desirable characteristics of the macro observation system;

FIG. 15 is a graph illustrating a relationship between the number of wells and the ratio of the observable region of a well bottom surface;

FIG. 16 is a table illustrating a relationship between a numerical aperture, a depth of field, and a cutoff frequency;

FIG. 17 is a graph illustrating a relationship between a frequency and an MTF;

FIG. 18 is a diagram illustrating an example of a lens configuration of the macro observation system;

FIG. 19 is a diagram illustrating another example of the lens configuration of the macro observation system;

FIG. 20 is a diagram illustrating still another example of the lens configuration of the macro observation system;

FIG. 21 is a diagram for explaining an example of a desirable arrangement relationship between a macro observation system and a micro observation system according to a second embodiment, and illustrating an example in which a slide-type nosepiece is present at a reference position;

FIG. 22 is a diagram for explaining an example of a desirable arrangement relationship between the macro observation system and the micro observation system according to the second embodiment, and illustrating an example in which the slide-type nosepiece slides from the reference position;

FIG. 23 is a diagram for explaining an example of an undesirable arrangement relationship between the macro observation system and the micro observation system, and illustrating an example in which the slide-type nosepiece is present at the reference position;

FIG. 24 is a diagram for explaining an example of an undesirable arrangement relationship between the macro observation system and the micro observation system, and illustrating an example in which the slide-type nosepiece slides from the reference position;

FIG. 25 is a diagram for explaining another example of a desirable arrangement relationship between the macro observation system and the micro observation system, and illustrating an example in which the slide-type nosepiece is present at the reference position;

FIG. 26 is a diagram for explaining another example of a desirable arrangement relationship between the macro observation system and the micro observation system, and illustrating an example in which the slide-type nosepiece slides from the reference position; and

FIG. 27 is a diagram for explaining still another example of a desirable arrangement relationship between the macro observation system and the micro observation system according to the second embodiment.

### DESCRIPTION

When a macro observation system and a micro observation system are simply provided together, a device becomes large. This is because the micro observation system usually includes a nosepiece for switching an objective lens, and it is necessary to arrange the nosepiece and the macro observation system at a distance such that the nosepiece and the macro observation system do not interfere with each other in the device.

In addition, as the macro observation system and the micro observation system are arranged farther from each other, the distance that a stage moves at the time of switching from macro observation to micro observation becomes longer, and the waiting time of a user becomes longer. Therefore, when the macro observation system and the micro observation system are not appropriately arranged, the improvement of the throughput obtained by providing the macro observation system and the micro observation system together falls below the user's expectation.

In view of the above circumstances, embodiments of the present invention will be described below.

### First Embodiment

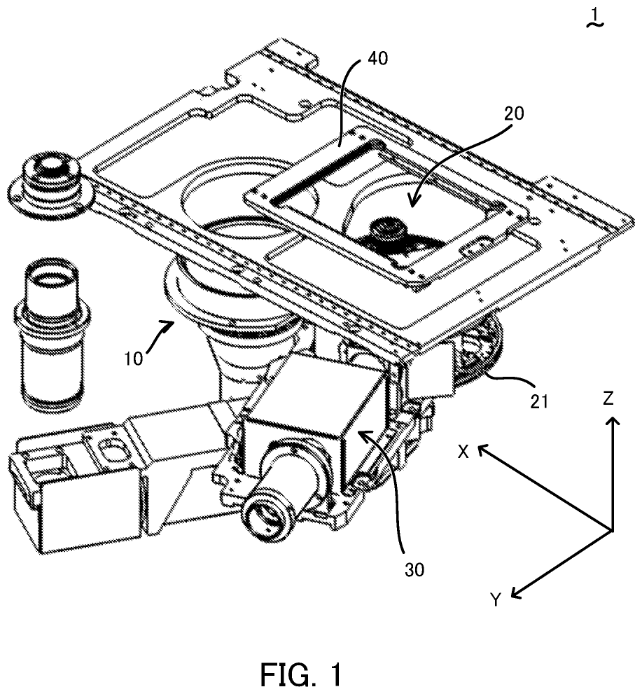

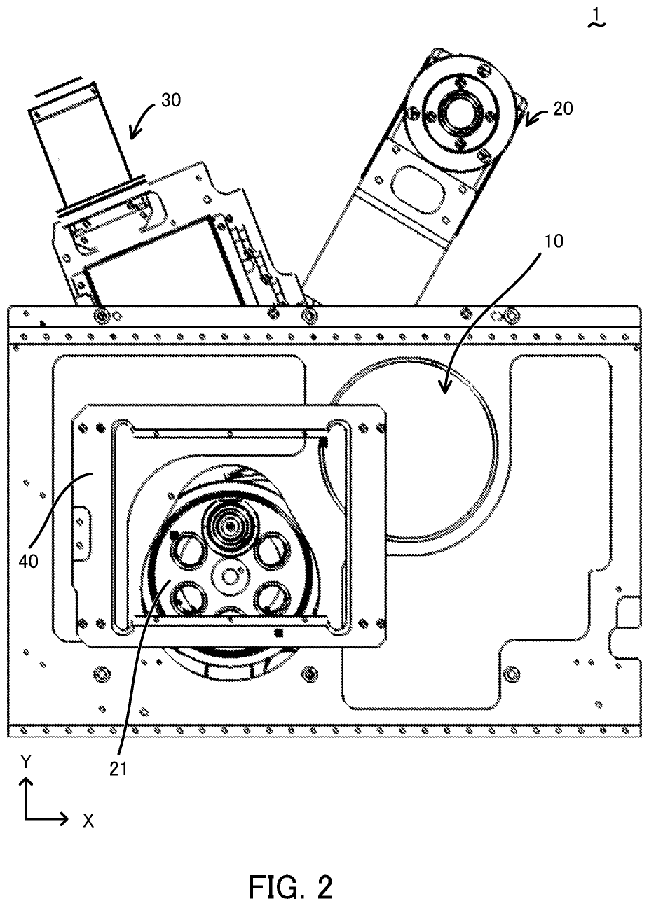

FIG. 1 is a perspective view of an observation device 1 according to the present embodiment. FIG. 2 is a top view of the observation device 1 according to the present embodiment. The observation device 1 is provided with a macro observation system 10 and a micro observation system 20, and is used for both macro observation and micro observation. The observation device 1 further includes an epi-illumination system 30 that is used for micro observation and an electric stage 40 on which a sample is placed.

As illustrated in FIG. 1, the observation device 1 is an inverted observation device in which both the macro observation system 10 and the micro observation system 20 are disposed below the electric stage 40. Therefore, the observation device 1 can observe the sample from the same direction by macro observation and micro observation.

The macro observation system 10 projects the sample at a reduced magnification and captures an image of the sample using an image sensor (not illustrated). Although not illustrated, the observation device 1 may include a transmissive illumination system corresponding to the macro observation system 10. The macro observation system 10 may be used to observe, from vertically below, the sample illuminated from vertically above by the transmissive illumination system.

The micro observation system 20 projects the sample at an equal magnification or an increased magnification and captures an image of the sample using an image sensor (not illustrated). As illustrated in FIGS. 1 and 2, the micro observation system 20 includes a nosepiece 21 to which a plurality of objective lenses is mountable. The nosepiece 21 is a revolving nosepiece. When the nosepiece 21 rotates about its rotation axis, the objective lens disposed on the optical axis of the micro observation system 20 is switched.

As illustrated in FIGS. 1 and 2, the micro observation system 20 has a configuration in which an optical path is bent in the middle. As a result, it is possible to prevent the position of the electric stage 40 from becoming too high with respect to the installation surface of the observation device 1. Therefore, the observation device 1 can provide the user with high workability for the sample placed on the electric stage 40.

The epi-illumination system 30 illuminates a region intersecting the optical axis of the micro observation system 20. As illustrated in FIGS. 1 and 2, the epi-illumination system 30 extends in a direction orthogonal to the optical axis of the micro observation system 20. Illumination light emitted from the epi-illumination system 30 is deflected in the optical axis direction of the micro observation system 20 by a beam splitter (not illustrated) provided on the optical axis of the micro observation system 20, and is guided to the sample placed on the electric stage 40. Unless otherwise specified, the optical axis of the micro observation system 20 is the optical axis of the micro observation system 20 on the object side, and coincides with the optical axis of the objective lens used for the micro observation. In addition, unless otherwise specified, the optical axis of the epi-illumination system 30 is the optical axis of the epi-illumination system 30 on the object side, and coincides with the optical axis of the objective lens used for the micro observation. That is, the optical axis direction of the epi-illumination system 30 refers to the optical axis direction of the objective lens. On the other hand, the direction of the optical axis of the epi-illumination system 30 before the light is deflected by the beam splitter toward the direction coincident with the optical axis of the objective lens is referred to as the extending direction of the epi-illumination system 30, and is distinguished from the optical axis direction of the epi-illumination system 30 described above.

The electric stage 40 is a moving stage for moving the sample. More specifically, the electric stage 40 is an XY stage that moves in a direction orthogonal to the optical axis of the macro observation system 10 and the optical axis of the micro observation system 20. By moving the electric stage 40, the sample placed on the electric stage 40 can be moved back and forth between the optical axis of the macro observation system 10 and the optical axis of the micro observation system 20, and the macro observation and the micro observation can be smoothly switched.

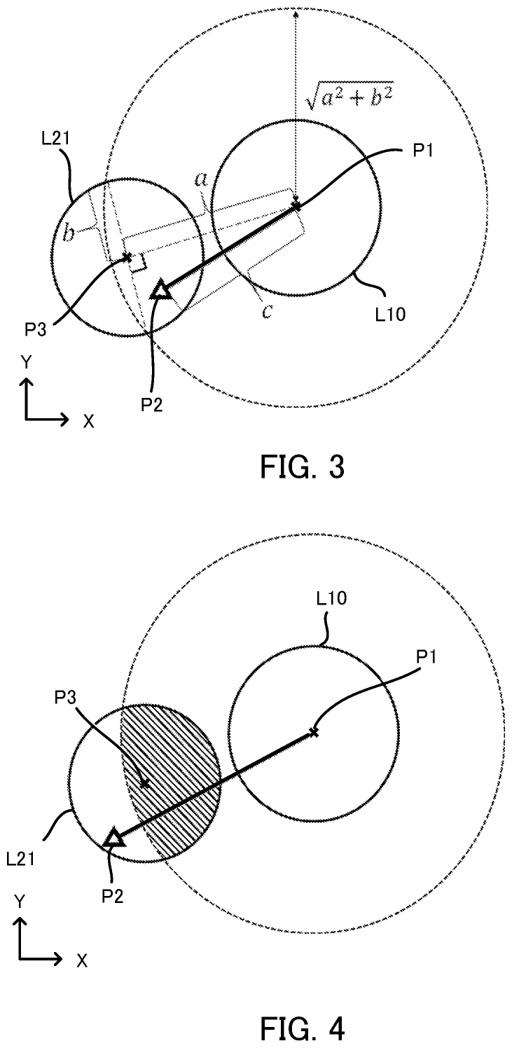

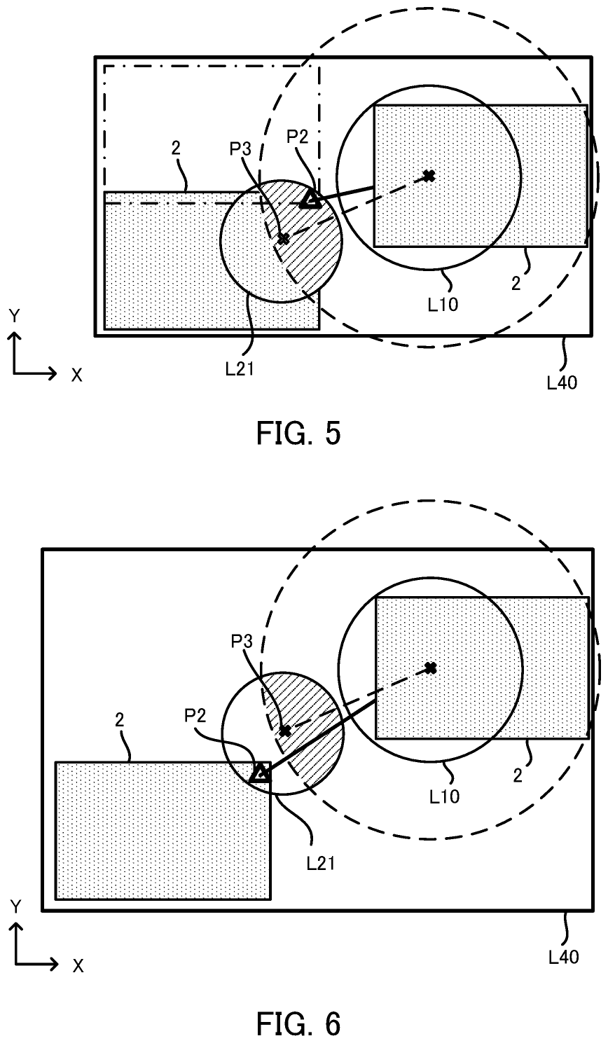

FIG. 3 is a diagram for explaining an example of a desirable arrangement relationship between the macro observation system and the micro observation system according to the present embodiment. FIG. 4 is a diagram for explaining an example of an undesirable arrangement relationship between the macro observation system and the micro observation system. FIG. 5 is a diagram illustrating a movable range of the electric stage in the arrangement relationship illustrated in FIG. 3. FIG. 6 is a diagram illustrating a movable range of the electric stage in the arrangement relationship illustrated in FIG. 4.

With reference to FIGS. 3 to 6, a desirable arrangement relationship between the macro observation system 10 and the micro observation system 20 will be described focusing on the distance between the optical axis of the macro observation system 10 and the optical axis of the micro observation system 20. Hereinafter, the optical axis of the macro observation system 10 is referred to as a macro optical axis P1, and the optical axis of the micro observation system 20 is referred to as a micro optical axis P2.

In order to make the observation device 1 compact and achieve high throughput, it is desirable to arrange the macro observation system 10 and the micro observation system 20 as close as possible. On the other hand, if the macro observation system 10 and the micro observation system 20 are too close to each other, for example, when the nosepiece 21 is rotated, the objective lens may come into contact with the macro observation system 10, and the macro observation system 10 and the micro observation system 20 may interfere with each other. In addition, even when the macro observation system 10 and the micro observation system 20 do not directly interfere with each other, the epi-illumination system 30 used for the micro observation may interfere with the macro observation system 10.

As a result of intensive studies in consideration of the above points, the inventor has found that the macro observation system 10 and the micro observation system 20 are desirably arranged to satisfy the following condition (hereinafter referred to as a first condition) as illustrated in FIG. 3. In FIG. 3, the side surface of the nosepiece 21 is represented by a contour line L21.

The first condition is that a distance c from the macro optical axis P1 to the micro optical axis P2 is less than or equal to the square root ((a²b²)^{1/2}) of the sum of squares of a first distance a and a second distance b.

The first distance a is the distance between the macro optical axis P1 and the central axis P3 of the outer diameter of the nosepiece 21.

The second distance b is the distance in a first direction between the central axis P3 of the outer diameter and the side surface of the nosepiece 21.

The first direction is a direction orthogonal to the macro optical axis P1 and orthogonal to a line segment connecting the macro optical axis P1 and the central axis P3 of the outer diameter.

That is, in the observation device 1, the macro observation system 10 and the micro observation system 20 are desirably arranged so as to satisfy c≤(a²+b²)^{1/2}. The first condition defines in which region of the nosepiece 21 the micro optical axis P2 should be arranged when the macro observation system 10 and the nosepiece 21 are arranged apart from each other such that the objective lens of the micro observation system 20 does not come into contact with the macro observation system 10 when the nosepiece 21 is rotated. Specifically, the first condition defines that the micro optical axis P2 is arranged such that the distance c between the optical axes is equal to or less than the predetermined distance (a²+b²)^{1/2}. A shaded region illustrated in FIG. 4 indicates a region where the micro optical axis P2 can be arranged when the first condition is satisfied.

When the arrangement of the macro observation system 10 and the nosepiece 21 (the macro optical axis P1 and the central axis P3 of the outer diameter) is determined as illustrated in FIGS. 3 and 4 such that the objective lens of the micro observation system 20 does not come into contact with the macro observation system 10, the arrangement of the micro optical axis P2 is limited to the region inside the contour line L21 of the nosepiece 21. In this case, for example, as illustrated in FIG. 4, when the micro optical axis P2 is arranged at a position relatively far from the macro optical axis P1 in the region inside the contour line L21, the amount of movement of the electric stage 40 is large at the time of switching from the macro observation to the micro observation. Therefore, it is difficult to achieve high throughput. On the other hand, as illustrated in FIG. 3, when the micro optical axis P2 is arranged at a position relatively close to the macro optical axis P1 in the region inside the contour line L21, the amount of movement of the electric stage 40 is small at the time of switching from the macro observation to the micro observation, and it is possible to achieve high throughput.

As illustrated in FIGS. 5 and 6, by satisfying the first condition, an arbitrary position of the container 2 can be observed in a small footprint L40 of the electric stage 40. Specifically, the footprint L40 when the first condition illustrated in FIG. 5 is satisfied is smaller than the footprint L40 when the first condition illustrated in FIG. 6 is not satisfied. Therefore, it is possible to avoid a situation in which the movable range of the electric stage 40 is a constraint condition for making the observation device 1 compact.

In the first condition, by setting the distance c between the optical axes to be equal to or less than the square root of the sum of the squares of the first distance a and the second distance b, a degree of freedom is given to a region in which the micro optical axis P2 is arranged, as compared with a case where the distance c between the optical axes is, for example, equal to or less than the first distance a. This is because, for example, in a case where the micro optical axis P2 is arranged between the macro optical axis P1 and the central axis P3 of the outer diameter, while the amount of movement of the stage can be suppressed to be short, it is necessary to insert one end of the epi-illumination system 30 into a space between the macro optical axis P1 and the central axis P3 of the outer diameter, and it is difficult to arrange the epi-illumination system 30 without a contact of the epi-illumination system 30 with the macro observation system 10. By setting the distance c between the optical axes to be equal to or less than the square root of the sum of the squares of the first distance a and the second distance b, it is easy to arrange the macro observation system 10 and the micro observation system 20 such that the epi-illumination system 30 does not interfere with the macro observation system 10. Therefore, the observation device 1 can be made compact while the macro observation system 10 and the micro observation system 20 are not arranged farther from each other than necessary in order to arrange the epi-illumination system 30.

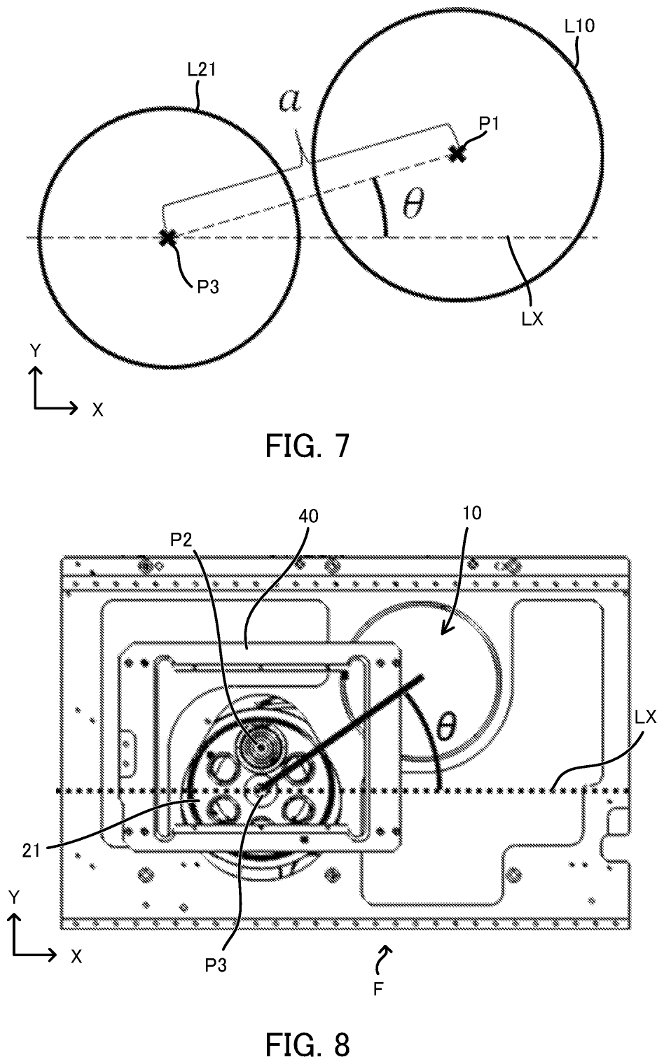

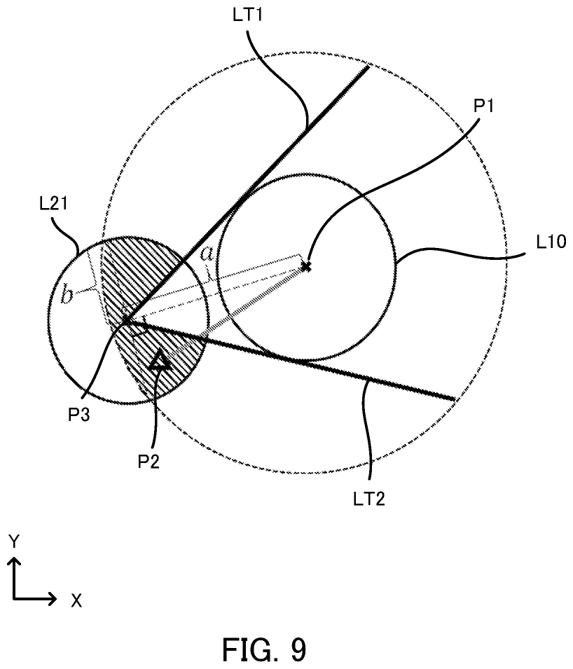

FIG. 7 is a diagram for explaining another example of a desirable arrangement relationship between the macro observation system and the micro observation system according to the present embodiment. FIG. 8 is a top view of the observation device 1 with the arrangement relationship illustrated in FIG. 7. With reference to FIGS. 7 and 8, a desirable arrangement relationship between the macro observation system 10 and the micro observation system 20 will be described focusing on a direction in which the macro observation system 10 and the micro observation system 20 are aligned.

In a case where the surface of the observation device 1 facing the user is defined as the front surface of the observation device 1, in order to facilitate access to the sample in both macro observation and micro observation, it is desirable that the macro observation system 10 and the micro observation system 20 be aligned in a width direction (x direction) parallel to the front surface and orthogonal to the macro optical axis P1 rather than a depth direction (y direction) orthogonal to the front surface and orthogonal to the macro optical axis P1.

Specifically, it is desirable that the macro observation system 10 and the micro observation system 20 be arranged to satisfy the following condition (hereinafter referred to as a second condition) as illustrated in FIG. 7. In FIG. 7, a first plane is represented by a straight line connecting the macro optical axis P1 and the central axis P3 of the outer diameter. A second plane is represented by a straight line LX passing through the central axis P3 of the outer diameter.

The second condition is that an acute angle θ formed by the first plane and the second plane is 40 degrees or less.

The first plane is a plane including the macro optical axis P1 and the central axis P3 of the outer diameter.

The second plane is a plane parallel to the front surface of the observation device and parallel to the macro optical axis P1.

In the configuration that satisfies the second condition, as illustrated in FIG. 8, both the macro optical axis P1 (the center of the macro observation system 10) and the micro optical axis P2 are not so far away from the user seated near the front surface F. Therefore, even when the sample is placed on the macro optical axis P1 or placed on the micro optical axis P2, the user can easily access the sample from the front surface F side, which contributes to the improvement of the throughput.

As illustrated in FIG. 8, a small number of shields between the front surface F and the optical axes also contributes to the achievement of high accessibility. In addition, in this configuration, for example, it is easy to access components that are directly operated by the user, such as the objective lenses and a fluorescent filter cube, and are not the sample. Furthermore, by arranging the macro optical axis P1 and the micro optical axis P2 in the width direction (x direction), the shape of the entire observation device 1 tends to be a horizontally long shape long in the width direction (x direction). The tabletop surface of a laboratory desk on which the observation device 1 is installed also usually has a horizontally long shape. Therefore, this configuration is also desirable in that the tabletop surface can be effectively utilized.

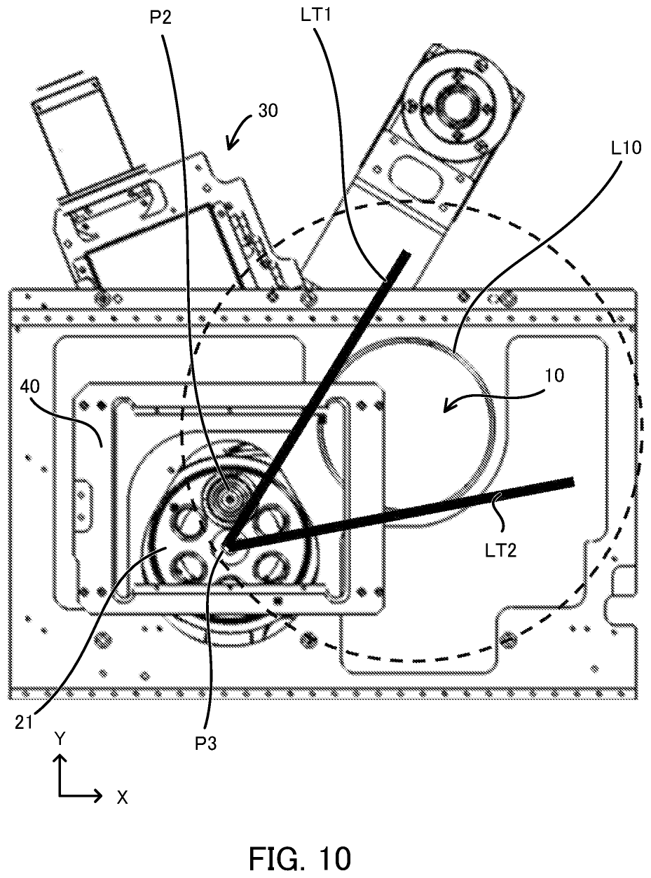

FIG. 9 is a diagram for explaining still another example of a desirable arrangement relationship between the macro observation system and the micro observation system according to the present embodiment. FIG. 10 is a top view of the observation device 1 with the arrangement relationship illustrated in FIG. 9. With reference to FIGS. 9 and 10, a desirable arrangement relationship between the macro observation system 10 and the micro observation system 20 will be described focusing on the positional relationship between the macro optical axis P1, the micro optical axis P2, and the central axis P3 of the outer diameter.

When the epi-illumination system 30 is used as an illumination system, the epi-illumination system 30 is disposed below the electric stage 40 in addition to the macro observation system 10 and the micro observation system 20. Therefore, in order to make the observation device 1 compact, it is necessary to arrange the macro observation system 10, the micro observation system 20, and the epi-illumination system 30 by efficiently using the space below the electric stage 40.

The epi-illumination system 30 extends in a direction (direction parallel to the xy plane) parallel to the electric stage 40, but one end of the epi-illumination system 30 extends to the micro optical axis P2. Considering this point, in order to prevent the epi-illumination system 30 from interfering with the macro observation system 10 and the nosepiece 21, the micro optical axis P2 is desirably arranged at a position deviated from a plane connecting the macro optical axis P1 and the central axis P3 of the outer diameter.

Specifically, it is desirable that the macro observation system 10 and the micro observation system 20 be arranged to satisfy the following condition (hereinafter referred to as a third condition) as illustrated in FIG. 9. In FIG. 9, a region satisfying the first condition and the third condition is indicated by shading. A first cylinder is represented by a contour line L10, and two tangent planes are represented by a tangent line LT1 and a tangent line LT2.

The third condition is that the micro optical axis P2 is arranged in a first region.

The first region is a region that is one of two regions defined by two tangent planes drawn from the central axis P3 of the outer diameter toward the side surface of the first cylinder and corresponds to an obtuse angle formed by the two tangent planes.

The first cylinder is a cylinder having a diameter that is the maximum outer diameter of the macro observation system 10 and a cylindrical axis that is the macro optical axis P1.

In the configuration that satisfies the third condition, as illustrated in FIG. 10, the epi-illumination system 30 can be prevented from being inserted into a narrow space between the macro observation system 10 and the nosepiece 21. Therefore, the observation device 1 can be made compact while it is not necessary to arrange the macro observation system 10 and the micro observation system 20 too far apart from each other in order to arrange the epi-illumination system 30.

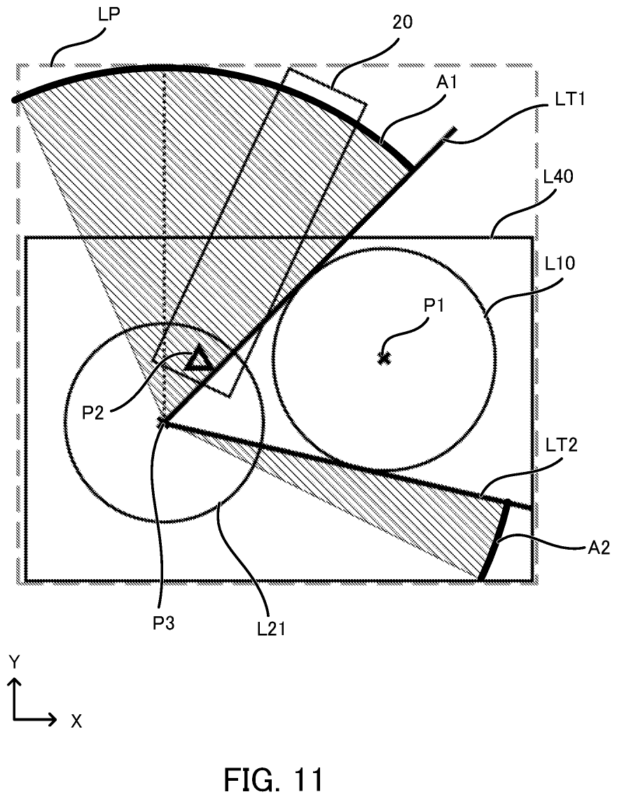

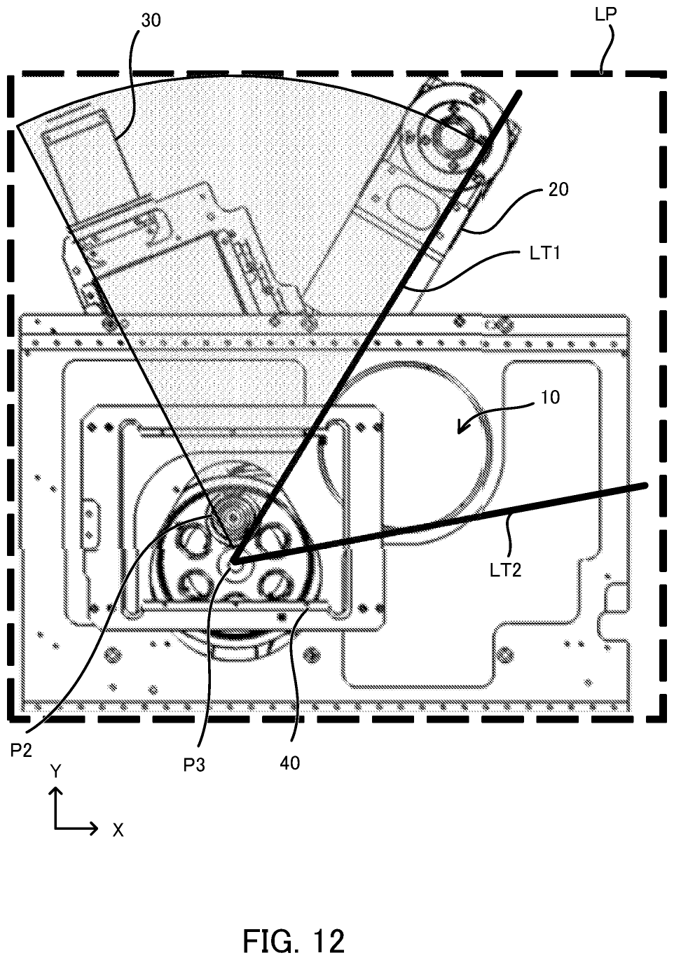

FIG. 11 is a diagram for explaining an example of a desirable arrangement of the epi-illumination system according to the present embodiment. FIG. 12 is a top view of the observation device 1 with the arrangement illustrated in FIG. 11. The desirable arrangement of the epi-illumination system 30 will be described below with reference to FIGS. 11 and 12 while focusing on a relationship with components other than the epi-illumination system 30.

The epi-illumination system 30 extends in the direction (direction parallel to the xy plane) parallel to the electric stage 40. Therefore, the footprint of the observation device 1 becomes large depending on the direction in which the epi-illumination system 30 is arranged. The epi-illumination system 30 is desirably arranged in an appropriate direction such that the footprint of the observation device 1 when the epi-illumination system 30 is arranged does not become excessively large with respect to the footprint of the observation device 1 when the epi-illumination system 30 is not arranged.

Specifically, it is desirable that the epi-illumination system 30 be arranged to satisfy the following condition (hereinafter referred to as a fourth condition) as illustrated in FIG. 11. Note that a projection plane is, for example, an xy plane on which the electric stage 40 moves. In FIG. 11, a region overlapping the first region and a third region is indicated by shading. The movable range of the electric stage 40 is represented by the footprint L40 of the electric stage 40, and a minimum rectangular region to be described later is represented by a contour line LP. The direction of a short side of the movable range is the depth direction (y direction) of the observation device 1.

The fourth condition is that an angle formed by the extending direction of the epi-illumination system 30 and the second plane is within the central angle range of an arc (arc A1, arc A2) formed by projecting the region overlapping the first region and the third region on the projection plane orthogonal to the optical axis P1 of the macro observation system 10. However, an angle within the central angle range is an angle with respect to the second plane.

A second region is the minimum rectangular region including all of the macro observation system 10, the micro observation system 20, and the movable range of the electric stage 40.

The third region is a region occupied by a cylinder having a radius that is a maximum distance in the direction (y direction) of the short side of the movable range of the electric stage 40 between the central axis P3 of the outer diameter and the contour line LP defining the second region, and a cylindrical axis that is the central axis P3 of the outer diameter.

In the configuration that satisfies the fourth condition, as illustrated in FIG. 12, the epi-illumination system 30 can be arranged without increasing the footprint of the observation device 1. Therefore, the observation device 1 can be made compact.

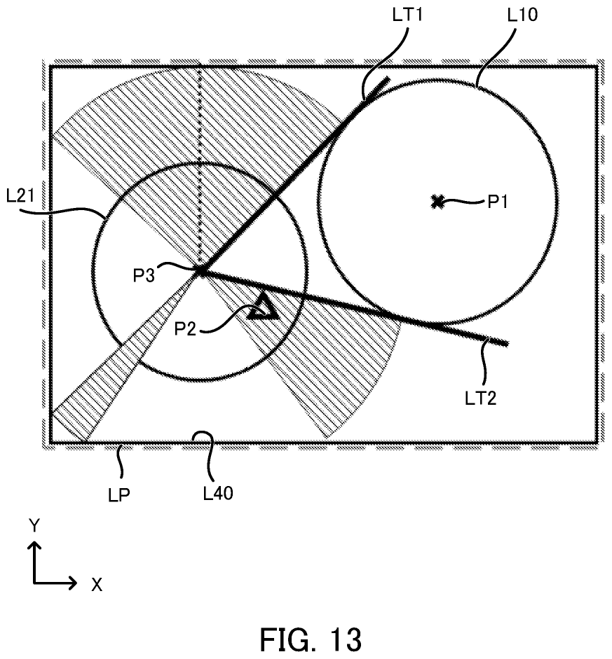

FIG. 13 is a diagram for explaining another example of a desirable arrangement of the epi-illumination system according to the first embodiment. Although the case where the micro observation system 20 has a configuration in which the optical path is bent in the middle has been described above as an example, the micro observation system 20 does not necessarily have a configuration in which the optical path is bent in the middle. FIG. 13 illustrates a desirable arrangement of the epi-illumination system in a case where the micro observation system 20 does not have a configuration in which the optical path is bent in the middle.

As illustrated in FIG. 13, in a case where the micro observation system 20 does not have a configuration in which the optical path is bent, the footprint of the observation device 1 is inevitably reduced. Therefore, the region where the epi-illumination system 30 can be arranged without increasing the footprint is also reduced. For this reason, the restriction on the size of the epi-illumination system 30 becomes strict. On the other hand, when the restriction on the size can be satisfied, the restriction on the direction of the epi-illumination system 30 becomes gentle as represented by a shaded region illustrated in FIG. 13, and the epi-illumination system 30 can be directed in a relatively free direction.

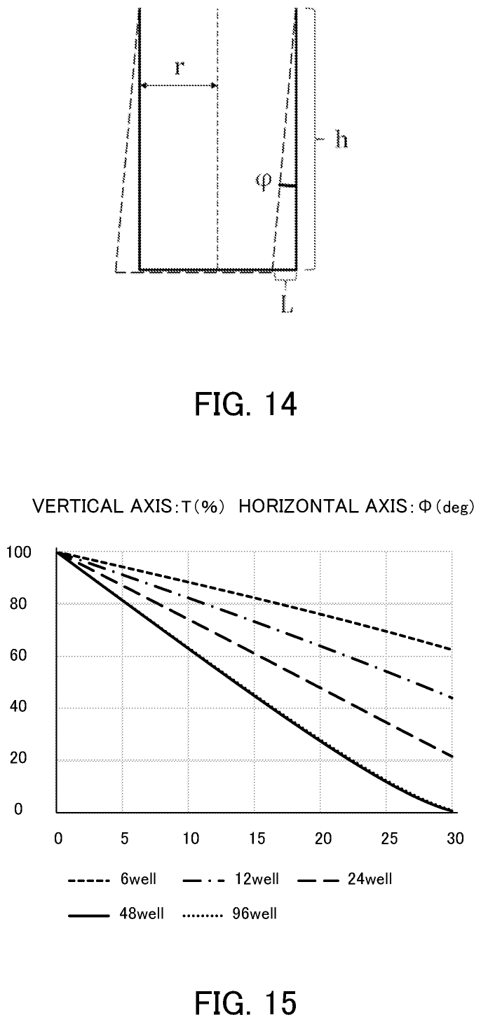

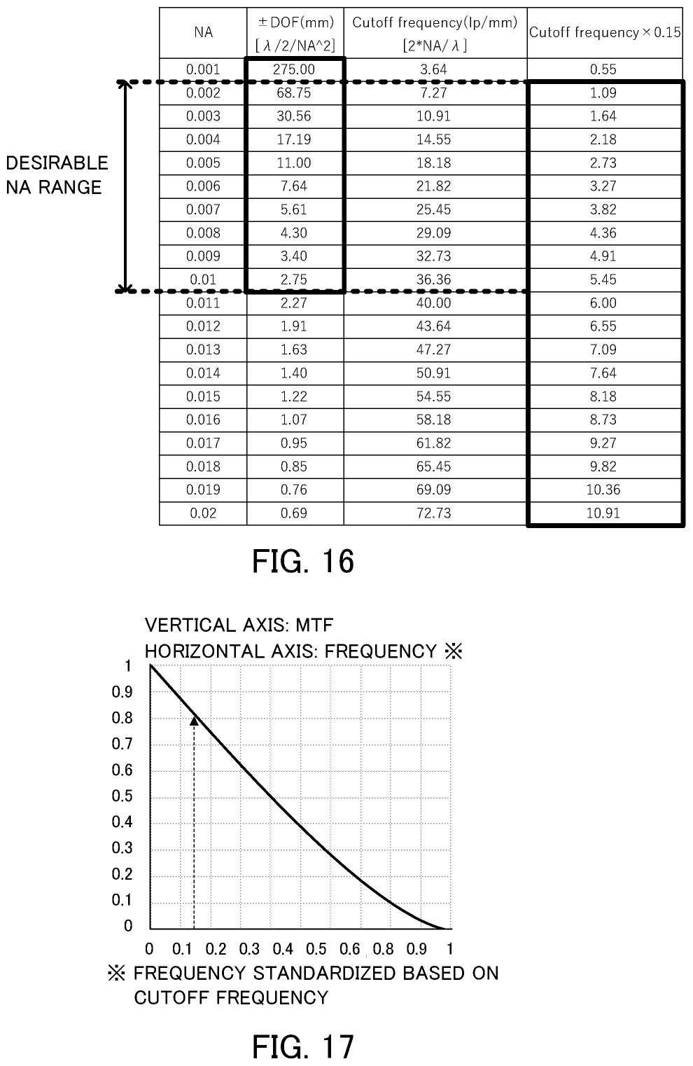

FIG. 14 is a diagram for explaining desirable characteristics of the macro observation system. FIG. 15 is a graph illustrating a relationship between the number of wells and the ratio of the observable region of a well bottom surface. FIG. 16 is a table illustrating a relationship between a numerical aperture, a depth of field, and a cutoff frequency. FIG. 17 is a graph illustrating a relationship between a frequency and an MTF. Desirable characteristics of the macro observation system 10 will be described below with reference to FIGS. 14 to 17.

The macro observation system 10 desirably has a wide field of view. Specifically, for example, assuming a well plate as the container 2, the diagonal length of the photographing range of the macro observation system 10 is desirably 80 mm or more. The size of a general well plate is determined to be 128 mm×85 mm. When the well plate is vertically divided into two, the diagonal length of the divided range is about 77 mm. Therefore, when the macro observation system 10 has a photographing range having a diagonal length of 80 mm, the observation device 1 can create an image of the entire well plate by photographing the well plate twice and synthesizing two images of the well plate.

The macro observation system 10 desirably has high telecentricity. Specifically, for example, when a well plate having many wells such as 96 wells is assumed as the container 2, the angle of an object-side most off-axis chief ray of the macro observation system 10 is desirably within ±5 degrees. As a result, since the state in each well can be correctly grasped by macro observation, the wells to be observed by micro observation can be appropriately identified.

The graph illustrated in FIG. 15 shows the results of calculating the observable area (hereinafter referred to as an aperture ratio) of the well bottom surface with respect to the actual area of the well bottom surface for each of well plates of 6 wells, 12 wells, 24 wells, 48 wells, and 96 wells on the basis of information (see FIG. 14) of the height h of each well and the radius r of the well bottom surface examined in advance. As the number of wells increases and the angle φ of the chief ray increases, an image of the side surface of each well is remarkably reflected on the well bottom surface, so that the aperture ratio tends to decrease as illustrated in FIG. 15. However, by suppressing the angle of the chief ray to 5 degrees or less, it is possible to normally observe 80% or more of the region of the wells even when the well plate having the 96 wells under the most severe conditions is used.

The macro observation system 10 generally does not have an autofocus function. Therefore, it is desirable that the macro observation system 10 have a deep depth of field. Specifically, the depth of field is desirably ±2.5 mm or more. The height of the well bottom surface of the well plate varies depending on the manufacturer of the well plate, the shape of the wells, and the like, but generally falls within the range of about 0.4 mm to 4.8 mm Therefore, in a case where the depth of field is 5 mm in the entire width, even when an autofocus function is not provided, it is possible to focus on the well bottom surface regardless of the well plate.

The macro observation system 10 desirably has a characteristic capable of identifying the wells of the well plate with high contrast. FIG. 16 is a table illustrating a relationship between the numerical aperture, the depth of field, and the cutoff frequency. In the optical system, the higher the numerical aperture, the higher the contrast and the higher the cutoff frequency, but on the other hand, the depth of field becomes narrower as illustrated in FIG. 16. Therefore, the numerical aperture of the macro observation system 10 is desirably designed such that the contrast and the depth of field are sufficient for the application of the macro observation system 10.

The side surface thickness of each well is about 1 mm. Therefore, in order to identify the wells with high contrast, it is desirable that the macro observation system 10 have high contrast with respect to the spatial frequency of 1 line/mm in the object plane. As illustrated in FIG. 17, at a frequency obtained by multiplying the cutoff frequency of the optical system by 0.15, the MTF indicates 80% or more of the maximum contrast. That is, since sufficiently high contrast can be obtained at a frequency 0.15 times the cutoff frequency, when a frequency 0.15 times the cutoff frequency is 1 mm or more in the optical system, the wells can be identified with good contrast. Furthermore, in consideration of the condition (±2.5 or more) required for the depth of field described above, a desirable range of the numerical aperture of the macro observation system 10 is, for example, 0.002 or more and 0.01 or less as illustrated in FIG. 16. That is, when the macro observation system 10 is provided for a well plate and has a numerical aperture in the range of 0.002 to 0.01, the macro observation system 10 can observe an arbitrary well plate with good contrast in a state in which the macro observation system 10 focuses on the well bottom surface.

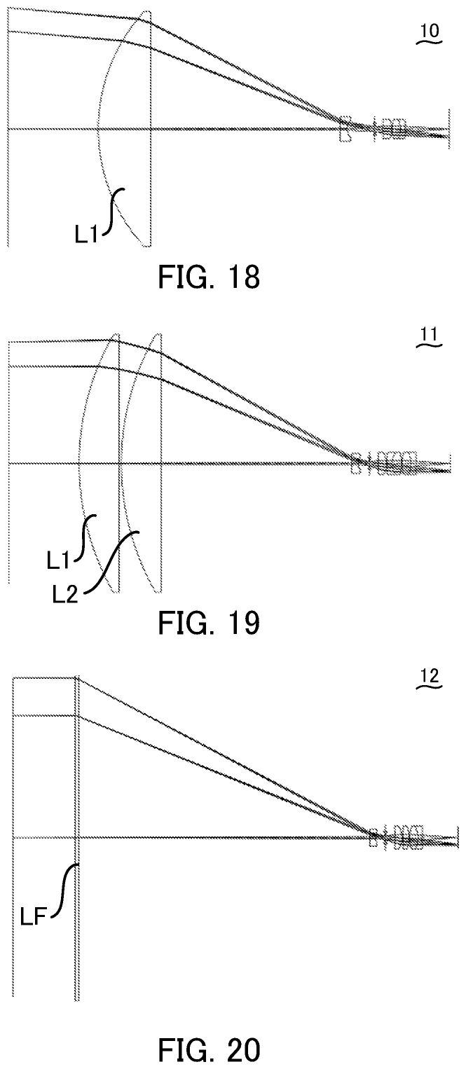

FIG. 18 is a diagram illustrating an example of a lens configuration of the macro observation system. FIG. 19 is a diagram illustrating another example of the lens configuration of the macro observation system. FIG. 20 is a diagram illustrating still another example of the lens configuration of the macro observation system. The examples of the lens configuration of the macro observation system will be described with reference to FIGS. 18 to 20.

As illustrated in FIG. 18, the macro observation system 10 includes one lens (lens L1) having a large diameter. Further, the macro observation system 10 includes a plurality of lenses in the vicinity of an aperture stop. Note that the number of large-diameter lenses is not limited to one, and a plurality of large-diameter lenses may be provided. A macro observation system 11 illustrated in FIG. 19 includes two large-diameter lenses (lens L1 and lens L2). The large-diameter lenses may be Fresnel lenses. A macro observation system 12 illustrated in FIG. 20 includes a large-diameter Fresnel lens (lens LF). The observation device 1 may use any optical system of the macro observation system 10 illustrated in FIG. 18 to the macro observation system 12 illustrated in FIG. 20.

### Second Embodiment

The observation device (hereinafter simply referred to as the present observation device) according to the present embodiment is different from the observation device 1 according to the first embodiment in that a slide-type nosepiece is used as a nosepiece of a micro observation system 20. The slide-type nosepiece is similar to the revolving nosepiece in that a plurality of objective lenses can be mounted, but is different from the revolving nosepiece in that an objective lens disposed on an optical axis of the micro observation system 20 is switched by moving the plurality of objective lenses in parallel. The other points are the same as or similar to those of the first embodiment. Note that, among the configurations included in the present observation device, configurations that are the same as or similar to the configurations included in the observation device 1 will be referred to using the same reference signs as the configurations included in the observation device 1.

Hereinafter, conditions that are desirable to be satisfied by the present observation device including the slide-type nosepiece in order to achieve a compact size and high throughput will be described.

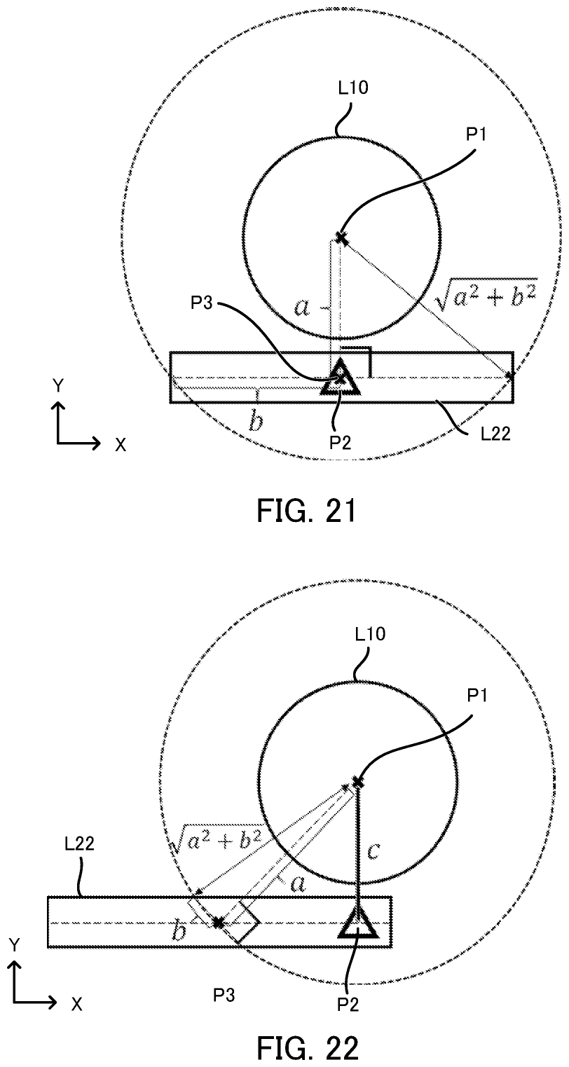

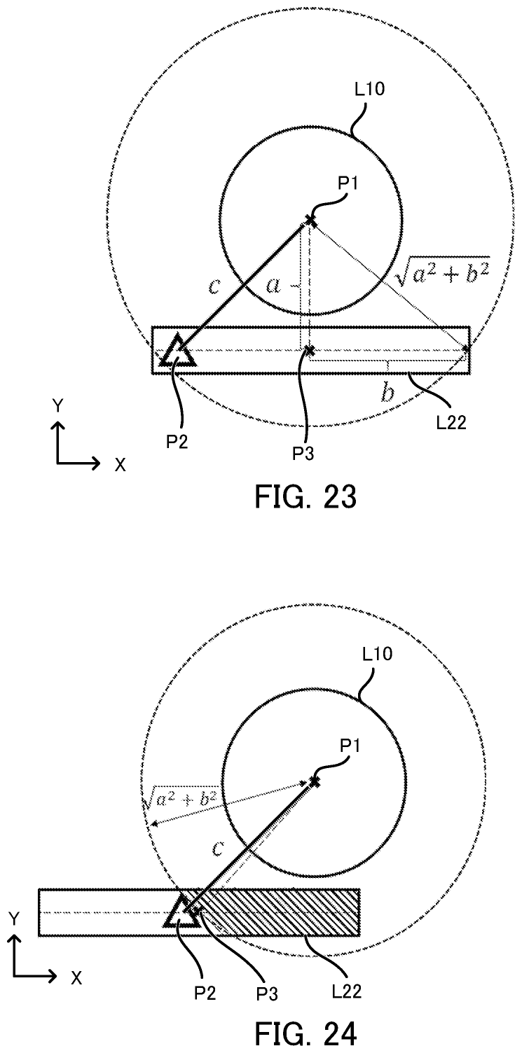

FIG. 21 is a diagram for explaining an example of a desirable arrangement relationship between the macro observation system and the micro observation system according to the present embodiment, and illustrating an example in which the slide-type nosepiece is present at a reference position. FIG. 22 is a diagram for explaining an example of a desirable arrangement relationship between the macro observation system and the micro observation system according to the present embodiment, and illustrating an example in which the slide-type nosepiece slides from the reference position. FIG. 23 is a diagram for explaining an example of an undesirable arrangement relationship between the macro observation system and the micro observation system, and illustrating an example in which the slide-type nosepiece is present at the reference position. FIG. 24 is a diagram for explaining an example of an undesirable arrangement relationship between the macro observation system and the micro observation system, and illustrating an example in which the slide-type nosepiece slides from the reference position.

Also in the present observation device, similarly to the observation device 1 according to the first embodiment, it is desirable that the macro observation system 10 and the micro observation system 20 be arranged so as to satisfy the first condition described above in the first embodiment. That is, the macro observation system 10 and the micro observation system 20 are desirably arranged so as to satisfy c≤(a²+b²)^{1/2}. In FIGS. 21 and 22, the contour of the nosepiece 22 is represented by a contour line L22.

Also in the present observation device, similarly to the observation device 1, the distance c between the macro optical axis P1 and the micro optical axis P2 is constant. However, since the central axis P3 of the outer diameter changes when the nosepiece 22 slides, the distance a and the distance b change depending on the state of the nosepiece 22 in the present observation device. In the present observation device, it is desirable that the macro observation system 10 and the micro observation system 20 be arranged so as to satisfy the first condition as illustrated in FIGS. 21 and 22, regardless of the state of the nosepiece 22. As a result, it is possible to prevent the macro optical axis P1 and the micro optical axis P2 from being too far from each other, so that the device can be made compact.

In the present observation device illustrated in FIGS. 21 and 22, the nosepiece 22 moves in a direction orthogonal to a line segment connecting the macro optical axis P1 and the micro optical axis P2. On the other hand, in an example illustrated in FIGS. 23 and 24 in which the macro observation system 10 and the micro observation system 20 are arranged so as not to satisfy the first condition, the sliding direction of the nosepiece 22 is different from the direction orthogonal to the line segment connecting the macro optical axis P1 and the micro optical axis P2. Such an arrangement causes the nosepiece 22 to move to a position far away from the macro observation system 10 depending on the state of the nosepiece 22. Therefore, it may be difficult to make the observation device compact.

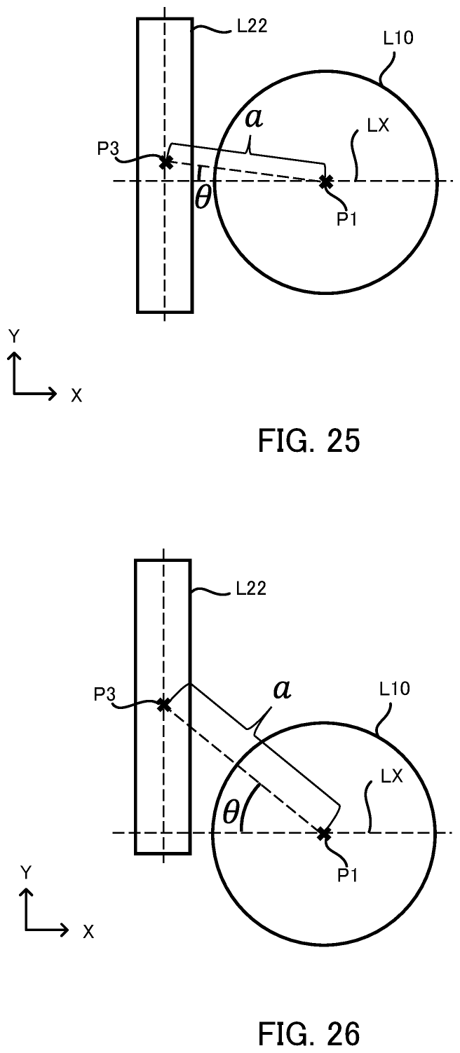

FIG. 25 is a diagram for explaining another example of a desirable arrangement relationship between the macro observation system and the micro observation system, and illustrating an example in which the slide-type nosepiece is present at the reference position. FIG. 26 is a diagram for explaining still another example of a desirable arrangement relationship between the macro observation system and the micro observation system, and illustrating an example in which the slide-type nosepiece slides from the reference position.

That is, the macro observation system 10 and the micro observation system 20 are desirably arranged so as to satisfy the second condition described above. In the present observation device, since the central axis P3 of the outer diameter changes when the nosepiece 22 slides, the angle θ changes depending on the state of the nosepiece 22. As illustrated in FIGS. 25 and 26, the sliding direction is set to the depth direction, and the macro observation system 10 and the micro observation system 20 are arranged such that the angle θ when the nosepiece 22 is present at the reference position is set to be sufficiently small, so that the second condition can be satisfied. Since the macro observation system 10 and the micro observation system 20 are arranged so as to satisfy the second condition, the macro observation system 10 and the micro observation system 20 are arranged in the width direction (x direction) of the device. Therefore, it is possible to provide a user with a device that is formed in a horizontally long shape as a whole, enables the sample to be easily accessed, and achieves high throughput.

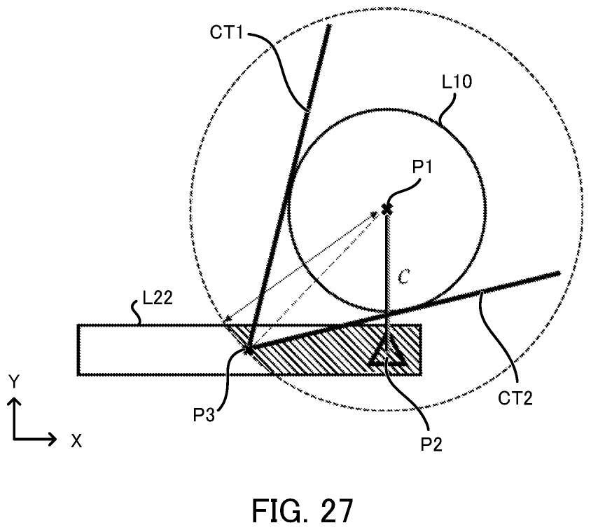

FIG. 27 is a diagram for explaining still another example of a desirable arrangement relationship between the macro observation system and the micro observation system according to the present embodiment.

That is, as illustrated in FIG. 27, the macro observation system 10 and the micro observation system 20 are desirably arranged so as to satisfy the third condition described above. By arranging the macro observation system 10 and the micro observation system 20 to satisfy the third condition, the epi-illumination system 30 can be prevented from being inserted into a narrow space between the macro observation system 10 and the nosepiece 22, and as a result, the observation device can be made compact. In FIG. 27, a region satisfying the first condition and the third condition is indicated by shading.

The above embodiments are specific examples for facilitating understanding of the invention, and the present invention is not limited to these embodiments. Modifications obtained by modifying the above embodiments and alternative forms replacing the above embodiments can be included. In other words, in each embodiment, the components can be modified without departing from the spirit and the scope thereof. Further, a new embodiment can be implemented by appropriately combining multiple components among the components disclosed in one or more of the embodiments. Further, some components may be omitted from the components described in each embodiment, or some components may be added to the components described in the embodiment. Further, the order of the processing procedures in each embodiment may be changed as long as there is no contradiction. That is, the observation device according to each of the embodiments of the present invention can be variously modified and changed without departing from the scope of the claims.

What is claimed is:

1. An observation device comprising:
a macro observation system that captures an image of a sample at a reduced magnification; and
a micro observation system that includes a nosepiece to which a plurality of objective lenses is mountable, and captures an image of the sample at an equal magnification or an increased magnification, wherein
the macro observation system and the micro observation system are arranged so as to satisfy a first condition,
the first condition is that a distance from a macro optical axis that is an optical axis of the macro observation system to a micro optical axis that is an optical axis of the micro observation system is equal to or less than a square root of a sum of squares of a first distance and a second distance,
the first distance is a distance between the macro optical axis and a central axis of an outer diameter of the nosepiece,
the second distance is a distance in a first direction between the central axis of the outer diameter and a side surface of the nosepiece, and
the first direction is a direction orthogonal to the macro optical axis and orthogonal to a line segment connecting the macro optical axis and the central axis of the outer diameter.

2. The observation device according to claim 1, wherein
the macro observation system and the micro observation system are arranged so as to satisfy a second condition,
the second condition is that an acute angle formed by a first plane and a second plane is 40 degrees or less,
the first plane is a plane including the macro optical axis and the central axis of the outer diameter, and
the second plane is a plane parallel to a front surface of the observation device and parallel to the macro optical axis.

3. The observation device according to claim 1, wherein
the macro observation system and the micro observation system are arranged so as to satisfy a third condition,
the third condition is that the micro optical axis is arranged in a first region, and
the first region is one of two regions defined by two tangent planes drawn from the central axis of the outer diameter of the nosepiece toward a side surface of a first cylinder and corresponds to an obtuse angle formed by the two tangent planes, and
the first cylinder is a cylinder having a diameter that is a maximum outer diameter of the macro observation system and a cylindrical axis that is the macro optical axis.

4. The observation device according to claim 2, wherein
the macro observation system and the micro observation system are arranged so as to satisfy a third condition,
the third condition is that the micro optical axis is arranged in a first region, and
the first region is one of two regions defined by two tangent planes drawn from the central axis of the outer diameter of the nosepiece toward a side surface of a first cylinder and corresponds to an obtuse angle formed by the two tangent planes, and
the first cylinder is a cylinder having a diameter that is a maximum outer diameter of the macro observation system and a cylindrical axis that is the macro optical axis.

5. The observation device according to claim 3, further comprising:
a moving stage that moves the sample; and
an epi-illumination system that illuminates a region intersecting the micro optical axis, wherein
the epi-illumination system is arranged so as to satisfy a fourth condition,
the fourth condition is that an angle formed by an extending direction of the epi-illumination system and a second plane is within a central angle range of an arc formed by projecting a region overlapping the first region and a third region on a projection plane orthogonal to the optical axis of the macro observation system and an angle within the central angle range is represented by an angle with respect to the second plane,
the second plane is parallel to a front surface of the observation device and parallel to the macro optical axis,
a second region is a minimum rectangular region including all of the macro observation system, the micro observation system, and a movable range of the moving stage, and
the third region is a region occupied by a cylinder having a radius that is a maximum distance in a direction of a short side of the movable range of the moving stage between the central axis of the outer diameter and a contour line defining the second region, and a cylindrical axis that is the central axis of the outer diameter.

6. The observation device according to claim 4, further comprising:
a moving stage that moves the sample; and
an epi-illumination system that illuminates a region intersecting the micro optical axis, wherein
the epi-illumination system is arranged so as to satisfy a fourth condition,
the fourth condition is that an angle formed by an extending direction of the epi-illumination system and a second plane is within a central angle range of an arc formed by projecting a region overlapping the first region and a third region on a projection plane orthogonal to the optical axis of the macro observation system, and an angle within the central angle range is represented by an angle with respect to the second plane,
the second plane is parallel to a front surface of the observation device and parallel to the macro optical axis,
a second region is a minimum rectangular region including all of the macro observation system, the micro observation system, and a movable range of the moving stage, and
the third region is a region occupied by a cylinder having a radius that is a maximum distance in a direction of a short side of the movable range of the moving stage between the central axis of the outer diameter and a contour line defining the second region, and a cylindrical axis that is the central axis of the outer diameter.

7. The observation device according to claim 1, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

8. The observation device according to claim 2, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

9. The observation device according to claim 3, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

10. The observation device according to claim 4, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

11. The observation device according to claim 5, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

12. The observation device according to claim 6, wherein
a diagonal length of a photographing range of the macro observation system is 80 mm or more,
an angle of an object-side most off-axis chief ray of the macro observation system is within ±5 degrees, and
a depth of field of the macro observation system is ±2.5 mm or more.

13. The observation device according to claim 1, wherein
the nosepiece is a revolving nosepiece.

14. The observation device according to claim 2, wherein
the nosepiece is a revolving nosepiece.

15. The observation device according to claim 3, wherein
the nosepiece is a revolving nosepiece.

16. The observation device according to claim 4, wherein
the nosepiece is a revolving nosepiece.

17. The observation device according to claim 5, wherein
the nosepiece is a revolving nosepiece.

18. The observation device according to claim 1, further comprising
a moving stage that moves the sample, wherein
the macro observation system is disposed on one of an upper side of the moving stage or a lower side of the moving stage, and
the micro observation system is disposed on the one side of the moving stage on which the macro observation system is disposed.

19. The observation device according to claim 5, wherein
the macro observation system is disposed on one of an upper side of the moving stage or a lower side of the moving stage,
the micro observation system is disposed on the one side of the moving stage on which the macro observation system is disposed, and
the epi-illumination system is disposed on the one side of the moving stage on which the macro observation system is disposed.

20. The observation device according to claim 6, wherein
the macro observation system is disposed on one of an upper side of the moving stage or a lower side of the moving stage,
the micro observation system is disposed on the one side of the moving stage on which the macro observation system is disposed, and
the epi-illumination system is disposed on the one side of the moving stage on which the macro observation system is disposed.
